(19) United States
(12) Patent Application Publication
(10) Pub. No.: US 2014/0248127 A1
(43) Pub. Date: Sep. 4, 2014

(54) TURBINE ENGINE COMPONENT WITH DUAL PURPOSE RIB

(71) Applicant: UNITED TECHNOLOGIES CORPORATION, (US)

(72) Inventors: Conway Chuong, Manchester, CT (US); Matthew Budnick, Tolland, CT (US)

(73) Assignee: UNITED TECHNOLOGIES CORPORATION, Hartford, CT (US)

(21) Appl. No.: 13/730,895

(22) Filed: Dec. 29, 2012

(51) Int. Cl. F02C 7/28

(52) U.S. Cl. CPC F02C 7/28
USPC 415/111

(57) ABSTRACT

An assembly for a gas turbine engine includes a component, a fairing, and a seal. The fairing is disposed adjacent to the component and defines a primary gas flow path. The fairing has a rib that is located outside of the primary flow path and extends from an outer surface of the fairing. The seal is disposed between the rib and the component.

### BACKGROUND

The invention relates to gas turbine engines, and more particularly to the retention of seals within gas turbine engines.

Gas turbine engines operate according to a continuous-flow, Brayton cycle. A compressor section pressurizes an ambient air stream, fuel is added and the mixture is burned in a central combustor section. The combustion products expand through a turbine section where bladed rotors convert thermal energy from the combustion products into mechanical energy for rotating one or more centrally mounted shafts. The shafts, in turn, drive the forward compressor section, thus continuing the cycle. Gas turbine engines are compact and powerful power plants, making them suitable for powering aircraft, heavy equipment, ships and electrical power generators. In power generating applications, the combustion products can also drive a separate power turbine attached to an electrical generator.

Fairings are used with vane assemblies and interface with the main gas flow path of the gas turbine engine. Fairings typically require stiffening features at the forward and aft ends thereof to maintain the circular shape and stiffness of the fairing. Seals are also used in many locations within the gas turbine engine to regulate air flow to various portions of the engine. Typically, seals require components such as seal lands and seal carriers for retention. These components add weight to, and therefore, decrease the efficiency of the gas turbine engine.

### SUMMARY

An assembly for a gas turbine engine includes a component, a fairing, and a seal. The fairing is disposed adjacent to the component and defines a primary gas flow path. The fairing has a rib that is located outside of the primary flow path and extends from an outer surface of the fairing. The seal is disposed between the rib and the component.

An assembly for a gas turbine engine includes a casing, a fairing, and a seal. The fairing is mounted within the casing and has a rib extending from an outer surface adjacent at least one of an aft end and a forward end of the fairing. The seal is disposed between the rib and the casing. The seal regulates a secondary gas flow to pass between the casing and the fairing.

An assembly for a gas turbine engine includes a casing, a fairing, and a W seal. The fairing is disposed within the casing and has a rib with a main body extending generally radially from an outer surface thereof. The rib has a lip extending from the main body. The W seal is mounted between the rib and the casing. The main body retains the W seal in an axial direction and the lip retains the W seal in a radial direction.

### BRIEF DESCRIPTION OF THE DRAWINGS

FIG. 1 is an industrial turbine cross-section.

FIG. 2 is a cross-section of an assembly including a fairing, ribs, a seal, and a frame arranged together.

FIG. 2A is an enlarged cross-sectional view of one embodiment of the seal retained by one of the ribs.

FIG. 3 is an enlarged cross-sectional view of another embodiment of a seal retained by a rib.

FIG. 4 is an enlarged cross-sectional view of yet another embodiment of a seal retained by to a rib.

### DETAILED DESCRIPTION

The application discloses the use of fairing ribs for both stiffening the fairing and for mounting seals within a gas turbine engine. Using the ribs for this dual purpose reduces the overall part count of the gas turbine engine and simplifies the design of the fairing for both manufacture and assembly. As a result of the arrangement described herein, the gas turbine engine is lighter and more cost effective to manufacture.

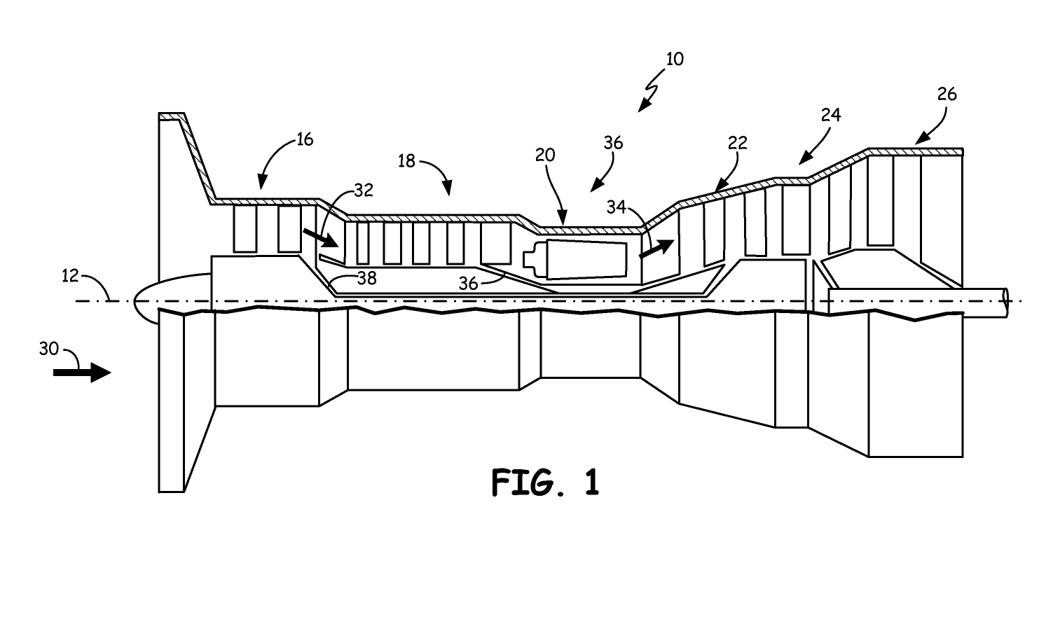

An exemplary industrial gas turbine engine 10 is circumferentially disposed about a central, longitudinal axis or axial engine centerline axis 12 as illustrated in FIG. 1. The engine 10 includes in series order from front to rear, low and high pressure compressor sections 16 and 18, a central combustor section 20 and high and low pressure turbine sections 22 and 24. In some examples, a free turbine section 26 is disposed aft of the low pressure turbine 24. Although illustrated with reference to an industrial gas turbine engine, this application also extends to aero engines with a fan or gear driven fan, and engines with more or fewer sections than illustrated.

As is well known in the art of gas turbines, incoming ambient air 30 becomes pressurized air 32 in the compressors 16 and 18. Fuel mixes with the pressurized air 32 in the combustor section 20, where it is burned to produce combustion gases 34 that expand as they flow through turbine sections 22, 24 and power turbine 26. Turbine sections 22 and 24 drive high and low pressure rotor shafts 36 and 38 respectively, which rotate in response to the combustion products and thus the attached compressor sections 18, 16. Free turbine section 26 may, for example, drive an electrical generator, pump, or gearbox (not shown).

It is understood that FIG. 1 provides a basic understanding and overview of the various sections and the basic operation of an industrial gas turbine engine. It will become apparent to those skilled in the art that the present application is applicable to all types of gas turbine engines, including those with aerospace applications.

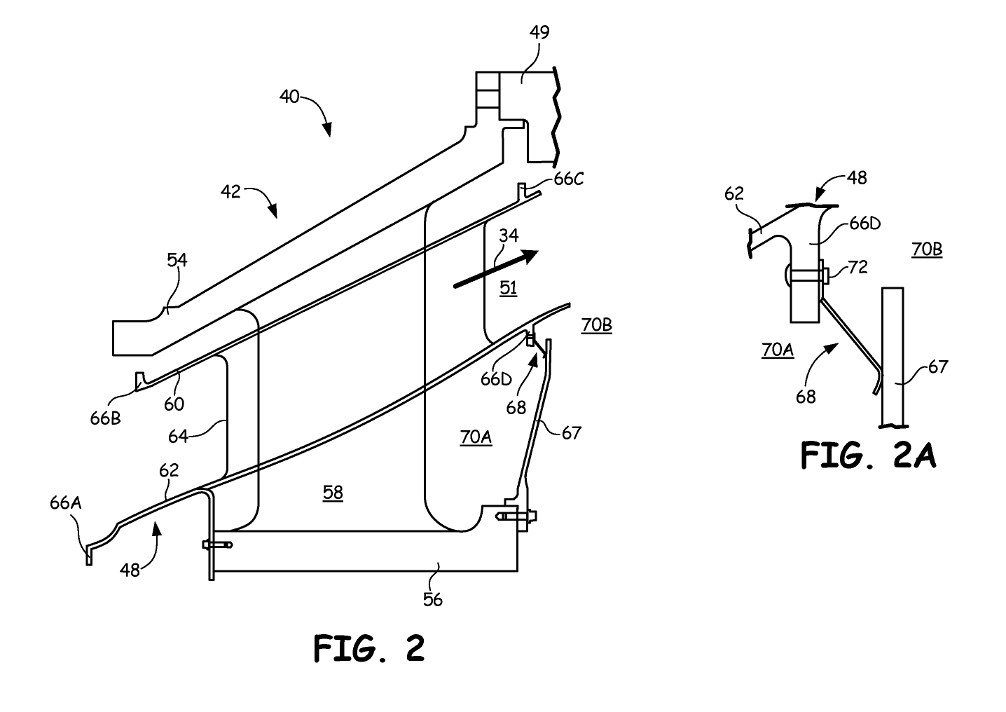

FIG. 2 shows a cross-section of assembly 40 with seal 68 retained by inner aft rib 66D and seal support 67. FIG. 2A shows an enlarged cross-section of seal 68, inner aft rib 66D, and seal support 67. Assembly 40 includes frame 42, fairing 48, and seal 68. Frame 42 includes outer radial casing 54, inner radial casing 56, and struts 58. Fairing 48 includes outer radial platform 60, inner radial platform 62, strut liners 64, and ribs 66A-66D.

Frame 42 comprises a stator component of gas turbine engine 10 (FIG. 1) and can form portions of compressor sections 16 and 18 and/or turbine sections 22 and 24. Fairing 48 is connected to the frame 42 when installed. Additionally, when installed fairing 48 is disposed within the frame 42 to form main gas flow path 51 for a portion of gas turbine engine 10 through which combustion gases 34 can flow.

As illustrated in FIGS. 2 and 2A, outer radial casing 54 of frame 42 is conically shaped and forms a portion of the casing of gas turbine engine 10 (FIG. 1), for example, in high pressure turbine section 22. Inner radial casing 56 is disposed generally radially inward of outer radial casing 54 and is connected thereto by struts 58.

Fairing 48 is adapted to be disposed within frame 42 between outer radial casing 54 and inner radial casing 56. Outer radial platform 60 of fairing 48 has a generally conical shape. Inner radial platform 62 has a generally conical shape. Inner radial platform 62 is spaced from outer radial platform 60 by strut liners 64. Strut liners 64 are adapted to be disposed around struts 58 of frame 42 when fairing 48 is assembled on frame 42. As discussed previously, outer radial platform 60, inner radial platform 62, and strut liners 64, form main gas flow path 51 for a portion of gas turbine engine 10 when assembled.

Outer radial casing 54 abuts and is affixed to a second outer radial casing 49 of another module of gas turbine engine 10 (FIG. 1). In the embodiment of FIG. 2, fairing 48 has ribs 66A-66D extending therefrom adjacent forward and aft ends. Both forward ribs 66A and 66B are positioned at or adjacent a forward extent of fairing 48. Forward ribs 66A and 66B extend circumferentially about inner radial platform 62 and outer radial platform 60, respectively. Forward ribs 66A and 66B are disposed outside of main gas flow path 51 and extend generally radially away from the non-main gas flow path side of fairing 48. Similarly, aft ribs 66C and 66D are positioned adjacent an aft extent of fairing 48. Aft ribs 66C and 66D extend circumferentially about outer radial platform 60 and inner radial platform 62, respectively. Aft ribs 66C and 66D are disposed outside of main gas flow path 51 and extend generally radially away from the non-main gas flow path side of fairing 48. Although illustrated as having a full 360° circumference in FIG. 2, ribs 66A-66D can be comprised of separate segments in other embodiments. Additionally, in other embodiments ribs can comprise a single rib located at any axial or radial location along fairing 48 not just adjacent forward and aft ends thereof.

As shown in FIGS. 2 and 2A, seal 68 is disposed between inner aft rib 66D and seal support 67. As shown in FIG. 2A, seal 68 is mounted to inner aft rib 66D and is affixed via fasteners 72. In other embodiments, seal 68 can be mounted to inner aft rib 66D by weld, rivet, adhesive, braze, or other means of connection. In the embodiment shown, seal 68 comprises a finger seal. In other embodiments, seal 68 can comprise another type of seal such as a W-seal, feather seal, dog-bone seal, etc.

As shown in FIG. 2A, seal 68 is mounted to inner aft rib 66D and contacts seal support 67. Thus, inner aft rib 66D acts as a seal carrier for seal 68 while seal support 67 acts as a seal land. In other embodiments, seal 68 can be mounted to seal support 67 such that inner aft rib 66D is contacted by seal (which acts as a seal land).

Inner aft rib 66B, seal 68, and seal support 67 act to separate cavities 70A and 70B within gas turbine engine 10 to limit the passage of a secondary gas flow therebetween. In particular, first cavity 70A is formed between seal 68, inner aft rib 66D, inner radial platform 62, seal support 67, and inner radial casing 56. Second cavity 70B is formed aft of seal 68, inner aft rib 66D and seal support 67.

Ribs 66A-66D act to maintain the shape of the fairing 48 and provide stiffness for the fairing 48. Additionally, inner aft rib 66D acts to mount seal 68 to seal against secondary gas flow between cavities 70A and 70B. The arrangement described reduces the overall part count of the gas turbine engine 10 and simplifies the design of fairing 48.

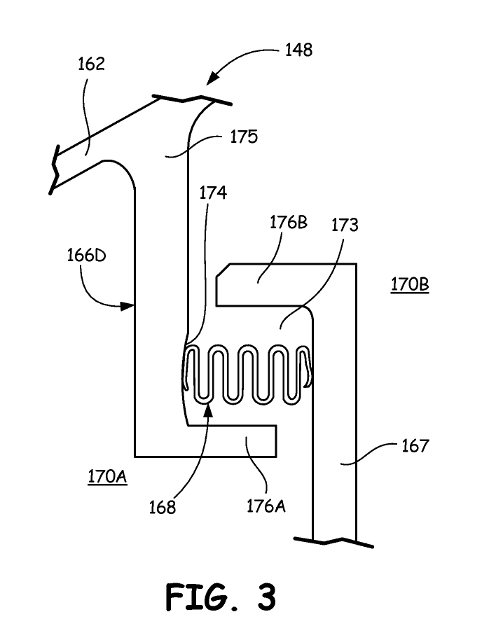

FIG. 3 shows a second embodiment of inner aft rib 166D, seal support 167, and seal 168. Inner aft rib 166D includes groove 174, main body 175, and lip 176A.

Main body 175 extends generally radially from inner radial platform 162 of fairing 148. Groove 174 is formed in aft surface of main body 175 to create a more effective sealing interface between inner aft rib 166D and seal 168. Lip 176A extends generally axially from main body 175 and is positioned inward of seal 168. In other embodiments, groove 174 may not exist and the seal 168 is contacted against the surface of the inner aft rib 166D.

Seal 168 is disposed between and is mounted to both inner aft rib 166D and seal support 167 within cavity 173. Seal 168 contacts both groove 174 as well as a generally radially extending portion of seal support 167. Main body 175 retains seal 168 in the axial direction and lip 176A retains seal 168 in the radial direction should seal 168 move in the radially inward direction.

In the embodiment shown in FIG. 3, seal support 167 includes lip 176B which extends generally axially and is positioned outward of seal 168. Similar to lip 176A of inner support rib 166D, lip 176B retains seal 168 in the radial direction should seal 168 move in the radially outward direction. Inner aft rib 166D, seal 168, and seal support 167 act to separate cavities 170A and 170B within gas turbine engine 10 to limit the passage of a secondary gas flow therebetween. In FIG. 3, seal 168 is illustrated as a W-seal. However, in other embodiments seal 168 can comprise another type of seal such as a finger seal, feather seal, dog-bone seal, etc.

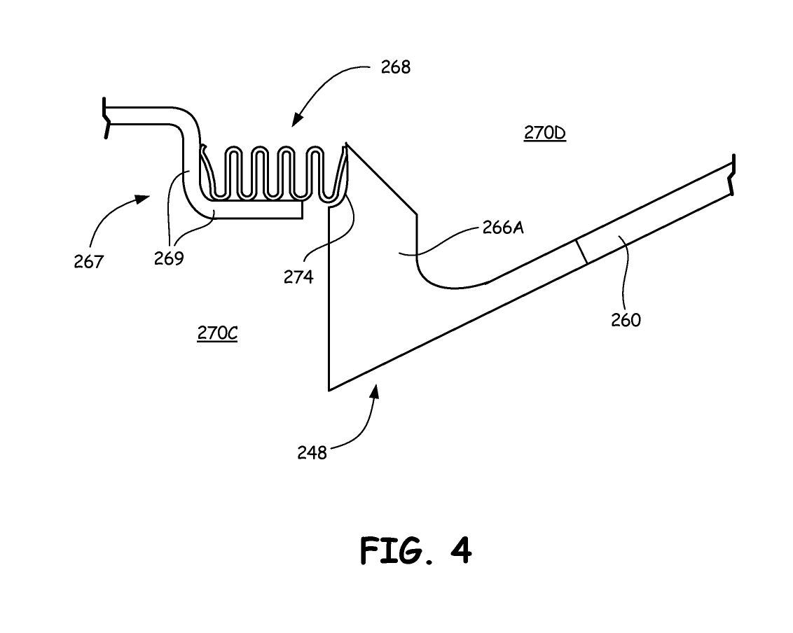

FIG. 4 shows another embodiment of outer forward rib 266A, seal carrier 267, and seal 268. Outer forward rib 266A includes groove 274.

Outer forward rib 266A extends generally radially from outer radial platform 260 of fairing 248. Groove 274 can be formed in forward interfacing surface of outer forward rib 266A to create a more effective sealing interface between outer forward rib 266A and seal 268.

Seal 268 is disposed between and is mounted to both outer forward rib 266A and seal carrier 267. Seal 268 contacts both groove 274 as well as pocket 269 of seal carrier 267 to create a seal. Outer forward rib 266A retains seal 268 in the axial direction and pocket 269 is adapted to retain seal 268 in both the radial direction as well as the axial direction. In FIG. 4, seal 168 is illustrated as a W-seal. However, in other embodiments seal 168 can comprise another type of seal such as a finger seal, feather seal, dog-bone seal, etc.

In the embodiment shown in FIG. 4, outer forward rib 266A acts as a seal land to interface with and retain seal 268 to create a seal. Outer forward rib 266A, seal 268, and seal carrier 267 act to separate cavities 270C and 270D within gas turbine engine 10 to limit the passage of a secondary gas flow therebetween.

### Discussion of Possible Embodiments

The following are non-exclusive descriptions of possible embodiments of the present invention.

An assembly for a gas turbine engine includes a component, a fairing, and a seal. The fairing is disposed adjacent to the component and defines a primary gas flow path. The fairing has a rib that is located outside of the primary flow path and extends from an outer surface of the fairing. The seal is disposed between the rib and the component.

The assembly of the preceding paragraph can optionally include, additionally and/or alternatively, any one or more of the following features, configurations and/or additional components:

the rib has a groove that receives the seal;

the rib extends generally radially from the fairing and retains the seal in the axial direction;

the rib has a lip extending therefrom that retains the seal in the radial direction;

the seal comprises a finger seal;

the seal comprises a W seal;

the component comprises a casing of a turbine frame;

the casing comprises one of a seal support or a seal carrier; and

the seal and the rib are disposed adjacent at least one of an aft end and a forward end of the fairing.

An assembly for a gas turbine engine includes a casing, a fairing, and a seal. The fairing is mounted within the casing and has a rib extending from an outer surface adjacent at least one of an aft end and a forward end of the fairing. The seal is disposed between the rib and the casing. The seal regulates a secondary gas flow to pass between the casing and the fairing.

The assembly of the preceding paragraph can optionally include, additionally and/or alternatively, any one or more of the following features, configurations and/or additional components:

the casing comprises a portion of a turbine frame;

the rib has a groove that receives the seal;

the rib extends generally radially from the fairing and retains the seal in the axial direction;

the rib has a lip extending therefrom that retains the seal in the radial direction;

the seal comprises a finger seal; and

the seal comprises a W seal.

An assembly for a gas turbine engine includes a casing, a fairing, and a W seal. The fairing is disposed within the casing and has a rib with a main body extending generally radially from an outer surface thereof. The rib has a lip extending from the main body. The W seal is mounted between the rib and the casing, and the main body retains the W seal in an axial direction and the lip retains the W seal in a radial direction.

The assembly of the preceding paragraph can optionally include, additionally and/or alternatively, any one or more of the following features, configurations and/or additional components:

the rib has a groove that receives the W seal;

the lip extends axially from the main body; and

the casing comprises one of a seal support or a seal carrier.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An assembly for a gas turbine engine, comprising:
a component;
a fairing disposed adjacent the component and defining a primary gas flow path, wherein the fairing has a rib located outside of the primary flow path and extending from an outer surface of the fairing; and
a seal disposed between the rib and the component.

2. The assembly of claim 1, wherein the rib has a groove that receives the seal.

3. The assembly of claim 1, wherein the rib extends generally radially from the fairing and retains the seal in the axial direction.

4. The assembly of claim 1, wherein the rib has a lip extending therefrom that retains the seal in the radial direction.

5. The assembly of claim 1, wherein the seal comprises a finger seal.

6. The assembly of claim 1, wherein the seal comprises a W seal.

7. The assembly of claim 1, wherein the component comprises a casing of a turbine frame.

8. The assembly of claim 7, wherein the casing comprises one of a seal support or a seal carrier.

9. The assembly of claim 7, wherein the seal and the rib are disposed adjacent at least one of an aft end and a forward end of the fairing.

10. An assembly for a gas turbine engine, comprising:
a casing;
a fairing mounted within the casing and having a rib extending from an outer surface adjacent at least one of an aft end and a forward end of the fairing; and
a seal disposed between the rib and the casing, wherein the seal regulates a secondary gas flow to pass between the casing and the fairing.

11. The assembly of claim 10, wherein the casing comprises a portion of a turbine frame.

12. The assembly of claim 10, wherein the rib has a groove that receives the seal.

13. The assembly of claim 10, wherein the rib extends generally radially from the fairing and retains the seal in the axial direction.

14. The assembly of claim 10, wherein the rib has a lip extending therefrom that retains the seal in the radial direction.

15. The assembly of claim 10, wherein the seal comprises a finger seal.

16. The assembly of claim 10, wherein the seal comprises a W seal.

17. An assembly for a gas turbine engine, comprising:
a casing;
a fairing disposed within the casing and having a rib with a main body extending generally radially from an outer surface and a lip extending from the main body; and
a W seal mounted between the rib and the casing, wherein a main body of the rib retains the W seal in an axial direction and the lip retains the W seal in a radial direction.

18. The assembly of claim 17, wherein the rib has a groove that receives the W seal.

19. The assembly of claim 17, wherein the lip extends axially from the main body.

20. The assembly of claim 17, wherein the casing comprises one of a seal support or a seal carrier.
